(19) United States
(12) Patent Application Publication
(10) Pub. No.: US 2018/0079388 A1
(43) Pub. Date: Mar. 22, 2018

(54) Vehicle Alert System and Method

(71) Applicant: Michelle Andrews, Pomona, CA (US)

(72) Inventor: Michelle Andrews, Pomona, CA (US)

(21) Appl. No.: 15/707,750

(22) Filed: Sep. 18, 2017

Related U.S. Application Data
(60) Provisional application No. 62/395,556, filed on Sep. 16, 2016.

(51) Int. Cl. B60R 25/30; B60R 25/31; B60R 25/104; B60R 25/102; H04N 5/232

(52) U.S. Cl. CPC B60R 25/305; B60R 25/31; B60R 2325/205; B60R 25/102; H04N 5/23293; B60R 25/104

(57) ABSTRACT

A vehicle alert system and method for notifying a user of a vehicle related event. The vehicle alert system includes a computer system having one or more vehicle computers operably connected to each other, an alert system comprising one or more cameras and one or more sensors, wherein the alert system is operably connected to the computer system, and a display system comprising one or more display units, wherein the display system is operably connected to the computer system. The method includes detecting motion within a proximity of a sensor, transmitting a captured image from the one or more cameras, and displaying the captured image on at least one of the following, the one or more vehicle computers, the one or more display units, or one or more client computers. In an alternative embodiment, the method further includes transmitting and displaying a user inputted indicia when motion is detected.

### CROSS REFERENCE TO RELATED APPLICATION

This application claims the benefit of U.S. Provisional Application No. 62/395,556 filed on Sep. 16, 2016. The above identified patent application is herein incorporated by reference in its entirety to provide continuity of disclosure.

### BACKGROUND OF THE INVENTION

The present invention relates to vehicle alert systems. More specifically, the present invention provides a vehicle alert system for notifying a user of an event relating to a vehicle, such as a potential theft or accident.

Many people own automobiles such as cars, trucks, and minivans. For most people, these vehicles are an extremely expensive purchase for the owner. Because of this, owners typically invest in a car with some sort of security system or alert system, such as a car alarm system or blind spot monitoring system, to help protect their investment.

The standard car alarm system only makes a noise to alert people within the vicinity of a car that it is being tampered with. The standard car alarm system also lacks a means to display visually what is occurring to a car when the alarm is sounding. Further, there is no other means to deter a potential thief from trying to break into the car.

Blind spot monitoring devices typically only blink a light when another car is in the blind spot of a user. These types of devices also lack a means of displaying visually what is around the exterior of the car, such as an oncoming vehicle that could potentially hit and damage the owner's car. Therefore, a vehicle alert system capable of transmitting images to third party devices or display units to warn a user of an incident such as a potential theft or accident is needed.

Devices have been disclosed in the known art that relate to alert systems for vehicles. These include devices that have been patented and published in patent application publications. These devices generally relate to anti-theft systems that include video surveillance systems disposed on an interior and exterior of a vehicle. These known art devices have several known drawbacks. Many of these anti-theft systems are only used to prevent theft and lack of means of notifying a user of a potential car accident. Many of these systems further lack a visual means on the exterior of a car to deter theft, such as a display panel that can display a captured image of a thief on the outside of the car. Lastly, these devices lack the ability to display programable indicia on the display.

In light of the devices disclosed in the known art, it is submitted that the present invention substantially diverges in design elements from the known art and consequently it is clear that there is a need in the art for an improvement to existing alert systems for vehicles. In this regard, the instant invention substantially fulfills these needs.

### SUMMARY OF THE INVENTION

In view of the foregoing disadvantages inherent in the known types of alert systems now present in the known art, the present invention provides a new vehicle alert system and method wherein the same can be utilized for providing convenience for the user when notifying a user of a vehicle related event, such as a potential theft or accident.

It is therefore an object of the present invention to provide a new and improved vehicle alert system and method that has all of the advantages of the known art and none of the disadvantages.

It is another object of the present invention to provide a vehicle alert system comprising a computer system including one or more vehicle computers operably connected to each other, an alert system comprising one or more cameras and one or more sensors, wherein the alert system is operably connected to the computer system, a display system comprising one or more display units, wherein the display system is operably connected to the computer system, and one or more client computers capable of receiving and displaying an image transmitted from the computer system over a wireless network.

Another object of the present invention is to provide a method performed by the computer system, the steps of the method include detecting motion, transmitting a captured image to at least one of the following, the one or more vehicle computers, the one or more client computers, or the one or more display units, displaying the captured image to at least one of the following, the one or more vehicle computers, the one or more client computers, or the one or more display units.

Yet another object of the present invention is to provide a method performed by the computer system with steps further including transmitting an inputted indicia to at least one of the following, the one or more vehicle computers, the one or more client computers, or the one or more display units, displaying the inputted indicia to at least one of the following, the one or more vehicle computers, the one or more client computers, or the one or more display units.

Another object of the present invention is to provide a vehicle alert system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a cutaway view of the vehicle alert system installed on a vehicle.

FIG. 2 shows a diagram of the vehicle alert system.

FIG. 3A shows a flowchart of an embodiment of the method of the vehicle alert system, wherein a captured image is displayed.

FIG. 3B shows a flowchart of an embodiment of the method of the vehicle alert system, wherein an inputted image is displayed.

### DETAILED DESCRIPTION OF THE INVENTION

Reference is made herein to the attached drawings. Like reference numerals are used throughout the drawings to depict like or similar elements of the vehicle alert system. For the purposes of presenting a brief and clear description of the present invention, the preferred embodiment will be discussed as a vehicle alert system installed on an automobile. However, the vehicle alert system may be used on any vehicle, such as vans, motorcycles, bicycles, or even toys. The figures are intended for representative purposes only and should not be considered to be limiting in any respect.

As used herein, “logic” refers to (i) logic implemented as computer instructions and/or data within one or more computer processes and/or (ii) logic implemented in electronic circuitry.

As used herein, “computer-readable medium” excludes any transitory signals, but includes any non-transitory data storage circuitry, e.g., buffers, cache, and queues, within transceivers of transitory signals.

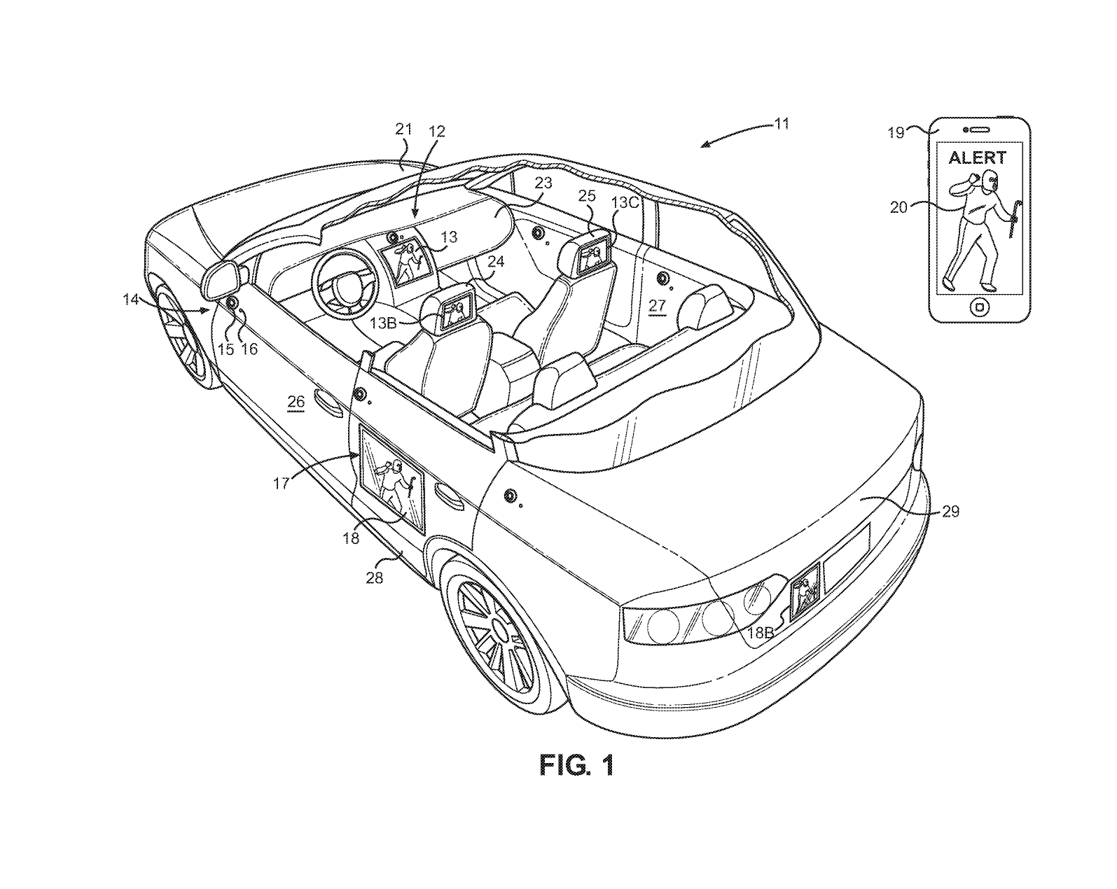

Referring now to FIG. 1, there is shown a cutaway view of the vehicle alert system installed on a vehicle. The vehicle alert system 11 comprises a computer system 12 including one or more vehicle computers 13 operably connected to each other, an alert system 14 comprising one or more cameras 15 and one or more sensors 16, and a display system 17 comprising one or more display units 18. The alert system 14 and the display system 17 are both operably connected to the computer system 12. The vehicle alert system 11 further includes one or more client computers 19 configured to receive and display an image 20 transmitted from the computer system 12.

Each of the one or more vehicle computers 13 of the computer system 12 are disposed on an interior of a vehicle 21. In the illustrated embodiment, a first vehicle computer 13 is disposed on a dashboard 23 of the vehicle 21, a second vehicle computer 13B is disposed on a sidewall of a driver side headrest 24, and a third vehicle computer 13C is disposed on a sidewall of a passenger side headrest 25. The one or more vehicle computers 13 are arranged in this configuration to allow multiple users to access the vehicle computers 13 while sitting in the vehicle 21. Each vehicle computer 13 comprises a graphical user interface (hereinafter “GUI”) that allows a user to access the controls via a touch screen. This allows multiple users to operate the computer system 12 at one time.

In some embodiments, the first vehicle computer 13 disposed on the dashboard 23 is configured to control the entire computer system 12, such that it can enable or disable access to other vehicle computers 13. This allows a user to disable access to other passengers in the vehicle, such as children, when deemed necessary by the user. In an alternative embodiment, access to the computer system 12 is only accessible through a fingerprint security scan using the GUI screen. In further embodiments, the GUI screen is configured to measure body temperature, pulse rate, and blood pressure, simply by touching and holding the screen with a user's hand. In an alternate embodiment, the first vehicle computer 13 may be configured to receive images from any linked client computer 19, such as an image from a mobile device or a doorbell camera that is capable of transmitting images via a network. In this way, a driver of the vehicle 21 will be notified on the vehicle computer 13 when a receiving an incoming call or if a person rings a doorbell linked to a doorbell camera.

In the illustrated embodiment, the alert system 14 includes multiple cameras 15 and sensors 16 disposed on both an exterior surface 26 and an interior surface 27 of the vehicle 21. The alert system 14 is configured to detect motion that occurs within a proximity of each sensor 16. The sensitivity of each sensor 16 can be adjusted via the computer system 12, such that a range for detecting motion in proximity to the sensor 16 can be increased or decreased, for example the sensors can be adjusted to detect motion within 5 feet of the sensor while the vehicle is parked, and decreased to 3 feet while the vehicle is being driven. When motion is detected by the sensor 16, the camera 15 is actuated and configured to capture an image 20 of an object that created the motion, such as a potential thief or another car hitting the vehicle. The captured image 20 can be in the form of a still image or a streaming video. Once detected and captured, this image 20 is transmitted to the one or more client computers 19, the one or more vehicle computers 13, and the one or more display units 18, in order to alert a user of the motion.

The vehicle computer 13 and the client computer 19 are both configured to allow a user to save the displayed image 20 on the memory of each respective computer. Access to the transmitted image 20 may be in the form of a mobile application downloaded to the vehicle computer 13 or the client computer 19. In an alternative embodiment, the captured image 20 is downloaded to a secure website where it can be accessed by a user via a password protected user profile. The website further includes options to forward the captured images to the proper authorities, such as the police. Further, a user can selectively activate the cameras of the vehicle alert system 11 to manually monitor the interior and exterior of the vehicle using a client computer. This allows a user to monitor the vehicle at anytime regardless of whether motion is detected.

The display system 17 of the vehicle alert system 11 is disposed on the exterior of the vehicle 21 and configured to show the image 20 captured by the camera 15. In the illustrated embodiment, a first display unit 18 is disposed on a door 28 of the vehicle 21 and a second display unit 18B is disposed on a rear 29 of the vehicle 21. Each display unit 18 is used to deter a potential thief from breaking into the vehicle by displaying externally a captured image of the potential thief, indicating that the vehicle is being monitored. In one embodiment, the alert system 14 includes a speaker disposed on the exterior of the vehicle, configured to allow a user to speak directly to a potential thief, warning them to stay away from the vehicle.

In an alternative embodiment, an indicia is transmitted and displayed on each display screen rather than the captured image from the camera 15. The indicia is inputted into the computer system 12 by a user. The indicia can be uploaded to the computer system 12 manually through the use of the GUI, a linked website, or from a client computer 19. When motion is detected by the sensor 16, the inputted indicia is transmitted from the computer system 12 and displayed as an image 20 on each vehicle computer 13, the display system 17, and the client computer 19. The indicia can be of any type, such as a cartoon or phrase, indicating that motion has been detected. Downloadable indicia can be inputted from a website containing different cartoons or characters. The website further includes tutorials on how to input the downloadable indicia into the vehicle alert system.

In one embodiment, the indicia would be transmitted and displayed while the vehicle 21 is being driven. In this embodiment, the indicia would be a phrase, such as “slow down” or “back off,” to indicate to a driver of an oncoming vehicle that they are too close in proximity to the user's vehicle 21. When motion is detected from the oncoming vehicle, the image 20 of the indicia will be displayed on the display screens of the entire system 11. Specifically, the external display units 19 would warn the driver of the oncoming vehicle to slow down, to prevent the driver from hitting the user's vehicle 21. However, even though the indicia is displayed and not a captured image from the one or more cameras 15, each camera 15 is configured to continue to capture images when motion is detected. In this way, if an accident does occur, the vehicle alert system 11 will capture how accident occurred.

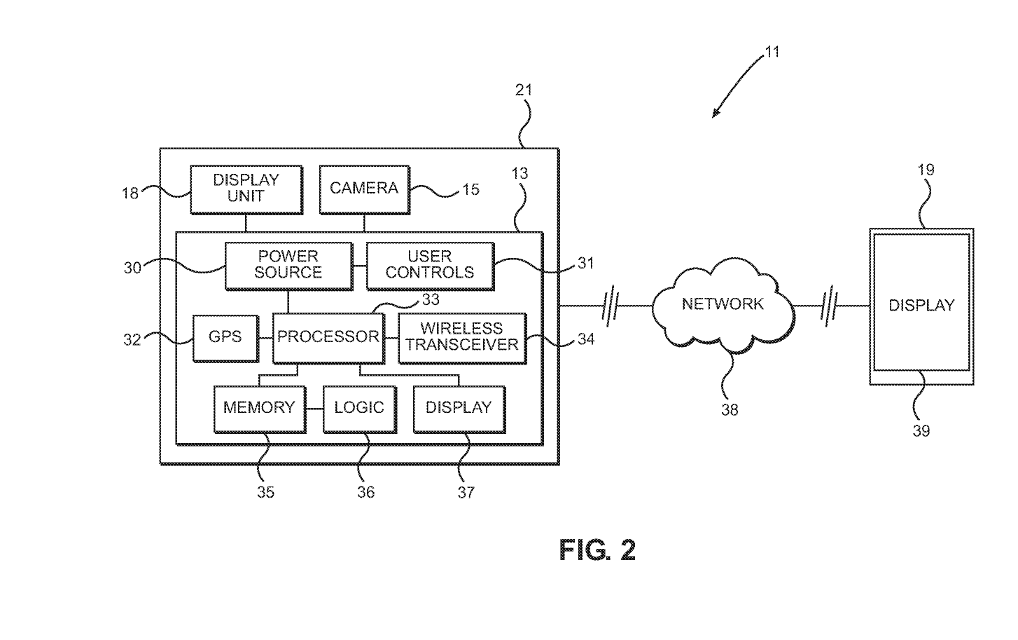

Referring now to FIG. 2, there is shown a diagram of the vehicle alert system. In the shown diagram, each of the one or more vehicle computers 13 of the vehicle alert system 11 are configured to communicate with a client computer 19 over a network 38. The client computer 11 may be embodied in any type of computer, such as a smart phone, laptop, smart tv, or tablet. Each vehicle computer 13 includes user controls 31 operatively connected to a power source 30. The vehicle computer 13 comprises a computer readable medium, which is shown here as a memory 35. The vehicle computer 13 further comprises a processor 33, and a logic 36 stored on the memory 35. When the logic 36 is executed, the processor 33 causes the vehicle computer 13 to perform a method according to the present invention 11.

The vehicle computer 13 further comprises a wireless transceiver 34 that is configured to send and receive information over the network 38, e.g. a telecommunications network, and a GPS system 32 that is configured to monitor the physical location of the vehicle computer 13 via one or more GPS satellites in operative communication therewith. The vehicle computer 13 also includes a display 37. The display 37 is configured to display a captured image from the one or more cameras or an indicia that is inputted into the vehicle computer 13 by a user. Each of the processor 33, memory 35, wireless transceiver 34, and display 37 are in operative communication with one another and with the power source 30. In the event of a vehicle 21 theft, a user can track the GPS location of the vehicle 21 via the GPS system 32 of the vehicle computer 13 that is linked over the network 38 with a client computer 19.

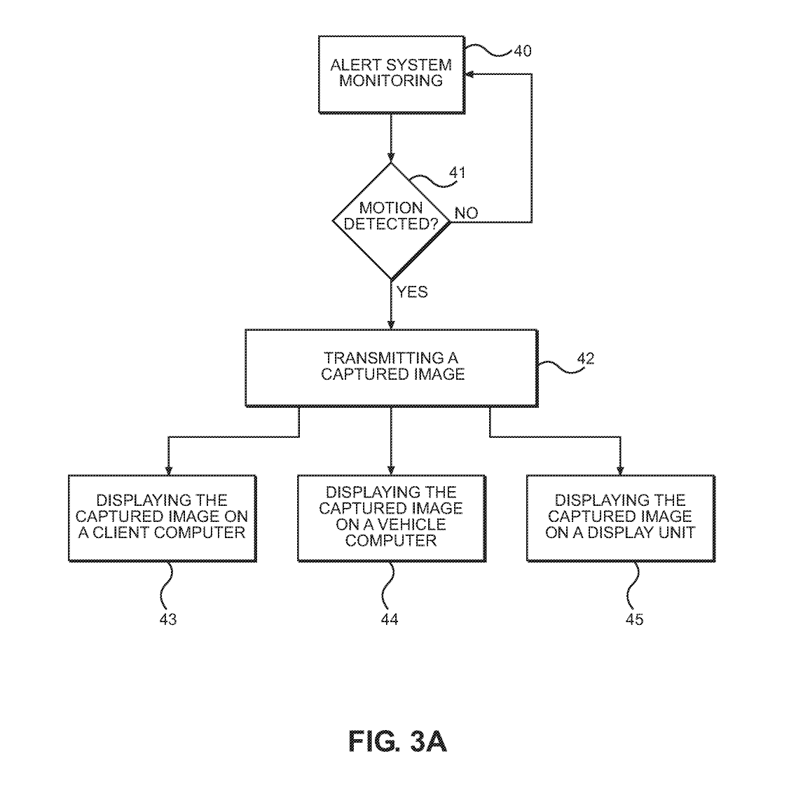

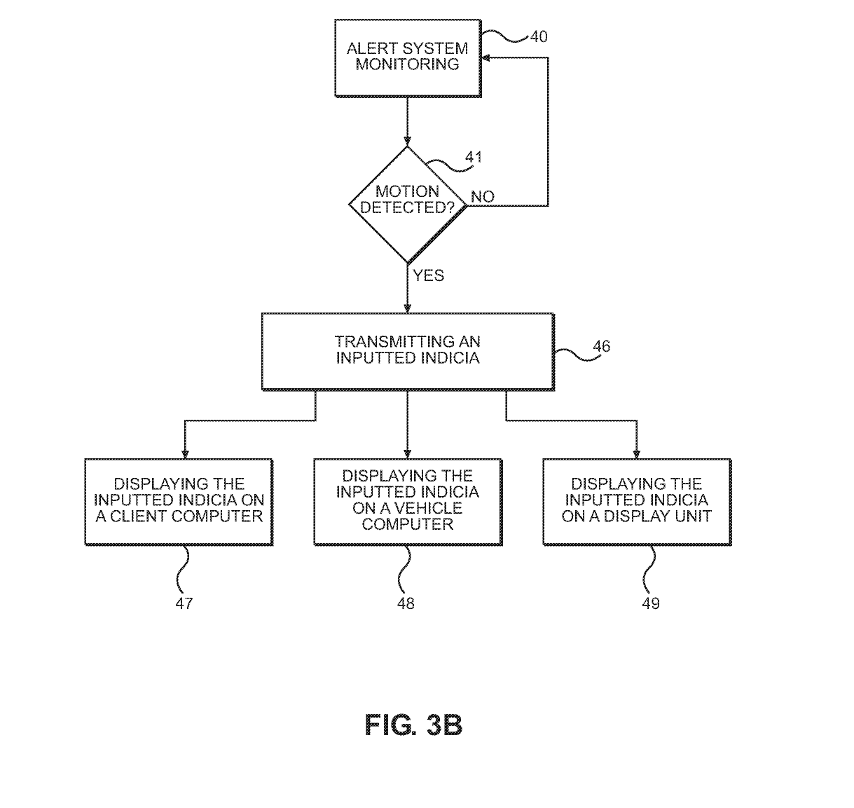

Referring now to FIG. 3A, there is shown a flowchart of an embodiment of the method, wherein a captured image is displayed. In the illustrated embodiment, the alert system continuously monitors 40 the interior and exterior of the vehicle for motion that occurs within a proximity to the one or more sensors. If no motion is detected 41, the alert system will continue to monitor the vehicle. If motion is detected 41, the cameras of the alert system will capture an image. The captured image can be in the form of a still or streaming image. The logic 36 of the vehicle computer 13 causes this image to be transmitted 42 to the client computer, the vehicle computer, and/or the display unit.

Once received, the captured image is displayed 43, 44, 45 on each client computer, vehicle computer, and display unit. The image displayed 43 on the client computer allows a user in a different location than the vehicle to receive an alert and image on their device warning them that the vehicle is being tampered with. In this instance, the user can download the video or still image of the potential thief and provide the image to the proper authorities. The image displayed 44, 45 on both the vehicle computer and display system are used to deter the thief from breaking into or stealing the vehicle.

Referring now to FIG. 3B, there is shown a flowchart of an embodiment of the method, wherein an inputted indicia is displayed. In the illustrated embodiment, a user inputs an indicia into the computer system, such as a cartoon image or a phrase. The indicia is configured to be transmitted by the vehicle computer 13 to multiple display screens while the vehicle is being driven if motion is detected. In this embodiment, the alert system continuously monitors 40 the exterior of the vehicle for motion that occurs within a proximity to the one or more sensors. If no motion is detected 41, the alert system will continue to monitor the exterior of the vehicle. If motion is detected 41, such as from an oncoming vehicle, the logic 36 of the vehicle computer 13 causes the indicia to be transmitted 42 to the client computer, the vehicle computer, and/or the display unit.

The inputted indicia is displayed 47 on the client computer to warn a user in a remote location that the vehicle was almost in an accident. The inputted indicia displayed 48 on the vehicle computer is configured to warn the user and passengers of the vehicle of a potential accident. The inputted indicia displayed 49 on the display unit on the exterior of the vehicle warns the driver of the oncoming vehicle that they are too close in proximity to the user's vehicle. This in turn, should cause the driver of the oncoming vehicle to decelerate or alter course in order to prevent an accident.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle alert system comprising:
a computer system including one or more vehicle computers operably connected to each other;
an alert system comprising one or more cameras and one or more sensors, wherein the alert system is operably connected to the computer system;
a display system comprising one or more display units, wherein the display system is operably connected to the computer system;
each of the one or more vehicle computers having:
a processor;
a non-transitory computer readable medium operatively connected to the processor;
a logic stored in the non-transitory computer readable medium that, when executed by the processor, causes the computer system to perform a method, the method comprising:
detecting motion;
transmitting a captured image to at least one of the one or more client computers or the one or more display units;
displaying the captured image to at least one of the following, the one or more client computers, the one or more display units, or the one or more vehicles computers;
each of the one or more client computers comprising:
a processor;
a non-transitory computer readable medium operatively connected to the processor;
a logic stored in the non-transitory computer readable medium that, when executed by the processor, causes the one or more client computers to perform a method, the method comprising:
receiving the captured image transmitted from the one or more vehicle computers;
displaying the captured image.

2) The vehicle alert system of claim 1, wherein the performed method of the computer system further comprises:
transmitting an inputted indicia to at least the one or more client computers or the one or more display units;
displaying the inputted indicia to at least one of the following, the one or more client computers, the one or more display units, or one or more vehicles computers.

3) The vehicle alert system of claim 1, wherein the performed method of the one or more client computers further comprises:
receiving an inputted indicia from the one or more vehicle computers;
displaying the inputted indicia.

4) The vehicle alert system of claim 1, wherein the alert system is configured to detect motion within a proximity to the one or more sensors.

5) The vehicle alert system of claim 1, wherein the display system is configured to display an image.

6) The vehicle alert system of claim 1, wherein a display on each the one or more vehicle computers and each of the one or more client computers is configured to display an image.

7) The vehicle alert system of claim 1, wherein the one or more vehicle computers are disposed on an interior surface of a vehicle.

8) The vehicle alert system of claim 7, wherein the one or more vehicle computers comprise a first vehicle computer disposed on a dashboard of the vehicle, a second vehicle computer disposed on a sidewall of a driver side headrest, and a third vehicle computer disposed on a sidewall of a passenger side headrest.

9) The vehicle alert system of claim 8, wherein the first vehicle computer is configured to control access to other vehicle computers.

10) The vehicle alert system of claim 1, wherein the one or more cameras and one or more sensors are disposed on an exterior surface of a vehicle.

11) The vehicle alert system of claim 1, wherein the one or more cameras and one or more sensors are disposed on an interior surface of a vehicle.

12) The vehicle alert system of claim 1, wherein the display system is disposed on an exterior surface of a vehicle.

13) The vehicle alert system of claim 1, wherein the display system comprises a first display unit disposed on a first side of a vehicle, and a second display unit disposed on a rear side of the vehicle.

14) The vehicle alert system of claim 1, wherein a speaker is operably connected to the computer system.

15) A computer-implemented method for detecting motion within a proximity of a vehicle, comprising:
detecting motion;
transmitting a captured image to at least one of the following, one or more client computers or one or more display units;
displaying the captured image to at least one of the following, the one or more client computers, the one or more display units, or one or more vehicles computers;
wherein each of the one or more client computers comprises:
a processor;
a non-transitory computer readable medium operatively connected to the processor;
a logic stored in the non-transitory computer readable medium that, when executed by the processor, causes the one or more client computers to perform a method, the method comprising:
receiving the captured image transmitted from the one or more vehicle computers;
displaying the captured image;
wherein the one or more display units are configured to receive and display the captured image.

16) The computer-implemented method of claim 15, further comprising:
transmitting an inputted indicia to at least one of the following, the one or more client computers or the display units;
displaying the inputted indicia to at least one of the following, the one or more client computers, the display units, or one or more vehicles computers.

17) A non-transitory computer readable medium that, when executed by a processor of one or more vehicle computers, causes the one or more vehicle computers to perform a method comprising:
detecting motion;
transmitting a captured image to at least one of the following, one or more client computers, or the display units;
displaying the captured image to at least one of the following, the one or more client computers, the display units, or the one or more vehicles computers;
wherein each of the one or more client computers comprises:
a processor;
a non-transitory computer readable medium operatively connected to the processor;
a logic stored in the non-transitory computer readable medium that, when executed by the processor, causes the one or more client computers to perform a method, the method comprising:
receiving the captured image transmitted from the one or more vehicle computers;
displaying the captured image;
wherein the one or more display units are configured to receive and display the captured image.

18) The non-transitory computer readable medium of claim 17, wherein the performed method further comprises:
transmitting an inputted indicia to at least one of the following, the one or more client computers or the display units;
displaying the inputted indicia to at least one of the following, the one or more client computers, the display units, or one or more vehicles computers.
